(19) United States
(12) Patent Application Publication
(10) Pub. No.: US 2012/0319903 A1
(43) Pub. Date: Dec. 20, 2012

(54) SYSTEM AND METHOD FOR LOCATING MOBILE DEVICES

(75) Inventors: Steve D. Huseth, Plymouth, MN (US); Soumitri N. Kolavennu, Minneapolis, MN (US); SrinivasaRao Katuri, Bangalore (IN); Abhishek Kumar Singh, Bangalore (IN)

(73) Assignee: Honeywell International Inc., Morristown, NJ (US)

(21) Appl. No.: 13/160,820

(22) Filed: Jun. 15, 2011

(51) Int. Cl. G01S 5/02

(52) U.S. Cl. 342/386

(57) ABSTRACT

A system includes a three dimensional antenna and mobile devices that wirelessly communicate with the antenna. A phase of arrival and a phase difference of arrival are calculated, and a distance between the three dimensional antenna and the mobile device is calculated. A direction between the three dimensional antenna and the mobile device is calculated. The direction calculation includes an angular spread function of multipath scattering in the communication between the three dimensional antenna and the mobile device. The direction calculation further includes an estimation of a propagation delay and an angle in the communication between the three dimensional antenna and the mobile device.

### TECHNICAL FIELD

The present disclosure relates to a system and method for locating mobile devices.

### BACKGROUND

In most search and rescue operations, an existing communication or aiding (geo-location) infrastructure for finding trapped personal may not be available, or feasible to set up, to accomplish the mission to save lives of victims as well as first responders. Specific operations like emergency route-finding for police, fire fighters, and military personnel, that depend on a building's existing wired or wireless radio infrastructure may not be a viable option due to the implications involved. This is particularly the case in firefighting scenarios where most of the existing geo-location infrastructure may be damaged, or scenarios where establishing a new communication and/or aiding system may not be easy. Most of the existing solutions today that are proposed to address this problem depend on a minimal amount of equipment. Such equipment includes three base stations coupled to a network of radios with a fusion of various signaling techniques such as radio frequency (RF), ultrasonic, infrared (IR), optical, and magnetic, and various positioning techniques such as multilateration, hyperbolic, and triangulation (used to meet accuracy limits). However these solutions have severe ranging errors due to the dense multipath nature of indoor environments. There is therefore a need for a stand-alone, single-station, infrastructure-less three dimensional location system for direction finding, positioning, and tracking of fire fighters and other personnel that need to be located.

### BRIEF DESCRIPTION OF THE DRAWINGS

FIG. 1 is a block diagram of a system for locating a mobile device.

FIG. 2 is a diagram of a system for locating a mobile device including a three dimensional antenna on a fire truck and a plurality of mobile devices in a building.

FIG. 3 is an illustration of the relationship between the azimuth angle, the elevation angle, and the range between a three dimensional antenna and a mobile device, and Cartesian coordinate data.

FIG. 4 is another illustration of the relationship between the azimuth angle, the elevation angle, and the range between a three dimensional antenna and a mobile device, and Cartesian coordinate data.

FIG. 5 illustrates a conversion of spherical coordinates to Cartesian coordinates.

FIG. 6 illustrates the relationship between the direction of arrival and a target position.

FIGS. 7A and 7B are a flowchart of an example embodiment of a process to determine the position of a mobile device using a three dimensional antenna.

FIGS. 8A and 8B are a flowchart of an example embodiment of a process to determine the position of a mobile device using two three dimensional antennas.

FIG. 9 is an example embodiment of a computer processor system that can be used in connection with an embodiment of the present disclosure.

### DETAILED DESCRIPTION

One or more embodiments address the need for a system for locating personnel that does not depend on an existing and intact building structure. These embodiments can have applications in the commercial, public safety, and military sectors. For example, in the commercial sector, these embodiments can be applied to residential and nursing homes to track people with special needs, the elderly, and children who are away from visual supervision, to navigate the blind, to locate in-demand portable equipment in hospitals, and to find specific items in warehouses. In the public safety and military sectors, embodiments could be applied to track inmates in prisons and navigate policemen, fire fighters, and soldiers to complete their missions inside buildings or other areas. One or more embodiments offer a robust direction of arrival (DOA) estimation technique, which improves the ranging performance of an indoor location system for a co-operative transmitter and receiver scenario. A co-operative transmitter and receiver scenario is a DOA-transceiver system, which uses known temporal information of the transmitted waveform and the preamble data of a communication protocol for estimating multipath delay or time of arrival.

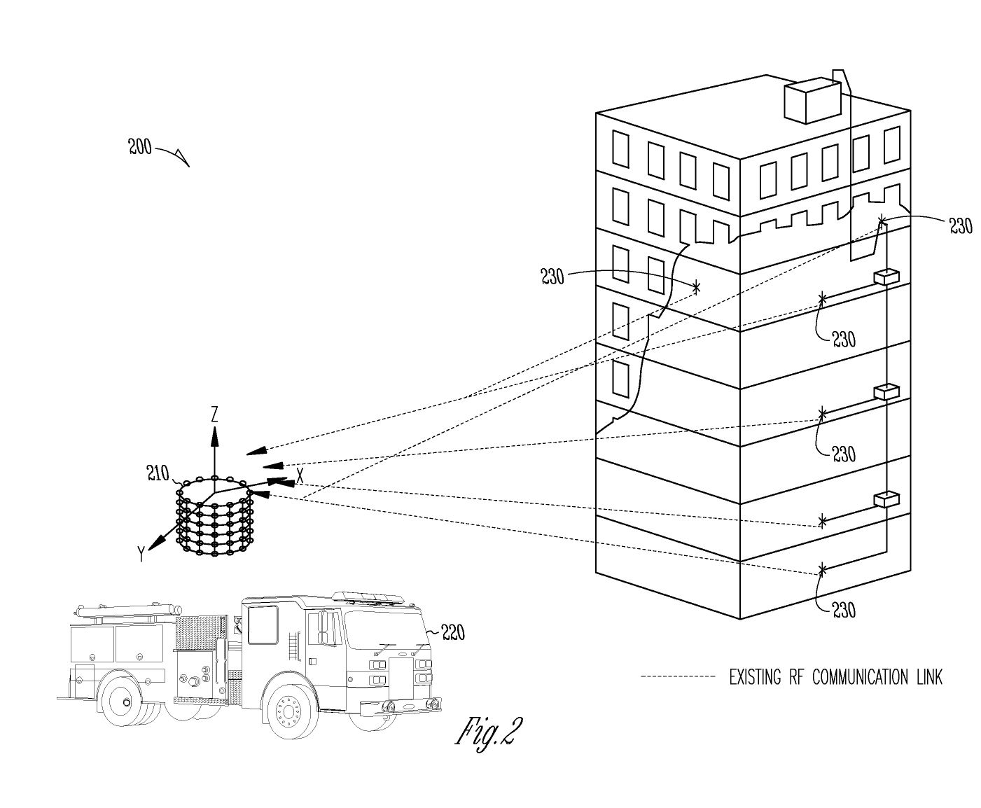

In an embodiment, such as illustrated in FIG. 2, a single-station three dimensional location system 200 combines a direction-of-arrival technique with a time/range for fixing a target location 230 in either an indoor or outdoor application. The embodiment includes an infrastructure-less or stand-alone single unit 220, 210 that is capable of estimating three dimensional location and tracking of single as well as multiple target radios that are worn by fire fighters or other personnel. Also included is antenna diversity for time/range. The phase of arrival (POA) or phase difference of arrival (PDOA) from non-collinear three dimensional plane antenna array geometry is used to compute time-of-arrival and/or time-difference-of-arrival for finding the range between the radios and the single station. The single station includes a semi-cylindrical rectangular micro strip patch antenna array that is capable of providing a receive beam scan in both azimuth and elevation planes. The system further provides robust DOA estimation algorithms for dense multipath indoor environments with <2° of angular accuracy. The DOA estimation techniques exploit the spatio-temporal properties of the indoor radio channel and then apply high resolution signal processing and statistical estimation techniques.

In an embodiment, the overall estimation procedure is segregated into two sequential stages. In a first stage, the impact of multipath due to surrounding scatterings is viewed as a distributed (point) sources and then it is modeled as a spread function in the angular domain. The true direction-of-arrival is the mean of the angular spread function, which is found by carrying a multi-dimensional search operation with a statistically efficient estimation technique such as Maximum-Likelihood (ML). In a second stage, a joint estimation of propagation delay and angle is estimated from channel state information by incorporating a spatio-temporal array manifold. The path with the smallest time delay is likely to be the direct path, whose direction is the actual direction of arrival.

An embodiment of the single station uses three dimensional antenna array geometry. Each element in the three dimensional antenna array has its own transmitter and receiver, which can be combined into a transmit-receive (T/R) module for converting the received signals into base band. The down-converted In-phase and Quadrature-phase (I/Q) base band signals are acquired through a multi-channel data acquisition card that is interfaced to a processor for real-time data acquisition. The acquired data is provided to two-stage DOA estimation algorithms. The key modules include a semi cylindrical micro strip patch antenna array (e.g., of size 6×20) that meets wide scanning coverage in azimuth and elevation planes with a very high gain (e.g., 21 dBm) and a very narrow beam width (14 dB). The receiver can be a dual band 915 MHz/2.4 GHz receiver suitable for narrow band applications such as downconversion and/or demodulation of the received signals. A field programmable gate array can be used for real-time data acquisition.

Most radio frequency (RF) ranging techniques such as Time of Arrival (TOA), Angle of Arrival (AOA), and Received Signal Strength Indicator (RSSI) that are used for estimating indoor locations have severe ranging errors due to dense indoor multipath. One or more embodiments describe a novel approach for robust DOA estimation that is based on Joint Angle and Delay (JADE) and Distributed Source Model (DSM) for known transmitted signal waveforms and communication protocol at the receiver.

The Joint Angle and Delay Estimation (JADE) approach relies on both the spatial and the temporal manifold, which results in increased robustness since the temporal manifold is known exactly and does not change with the environment. The JADE approach has several strengths. The array calibration and variability of the array response due to changes in the environment places severe limitation on the reliability of spatial model alone. The JADE approach relies on both temporal and spatial modeling, resulting in increased robustness. The path with the shorter delays are closer to the direct path, and the shortest delay path can be the direct path. Paths with longer delays have undergone more reflections and are more deviated from the direct path. Using JADE, more multipaths can be handled than the number of array elements. Conventional DOA algorithms are limited by the number of array elements.

The JADE approach also has some weaknesses. The JADE approach has a resolution problem in a dense multipath environment. If the direct path is blocked or is non-detectable, the JADE approach will be unable to detect the angle of arrival (AOA).

The Distributed Source Model (DSM) is a technique that estimates DOA based on the fact that the multipath is caused due to the reflections by the surrounding scatterings in the environment. The actual source which was modeled as the point source is now considered to become diffused. The scatterings are modeled as a virtual source around the actual one. The actual source and the scatterings taken together make the distributed source model of the environment. The distribution of the scatterings, and hence the reflected paths, is parameterized as the “angular spread” of the environment, and the actual angle is modeled as the “mean angle of arrival”. A cost function is designed using a covariance matrix of the sampled data and a structured covariance matrix. The algorithm carries out a search over the two parameters to minimize the cost function. The search over the two parameters for the entire field of view causes a very high computational burden.

There are several advantages to the DSM technique. It effectively models the environment by taking into account the actual source and the surrounding scatterings. It can also work under a dense multipath environment and non-line-of-sight (NLOS) scenarios. A shortcoming of the DSM approach is that the cost function minimization searches over the entire field of view and all possible angular spreads, and it is therefore computationally prohibitive.

An embodiment comprises a two stage algorithm that invokes the JADE in the first stage. The JADE of the first stage jointly estimates the multipath delay and the angle of arrival. The angle of arrival of the paths with shorter delays is taken into account to calculate the “nominal angle of arrival” and the “angular spread”. The output of the first stage is taken as the input to the second stage where the DSM technique is invoked. The search is initialized using the “nominal angle of arrival” and is carried over the range of the “angular spread” calculated in the first stage. Using the cost function minimization criterion, the actual angle of arrival is estimated.

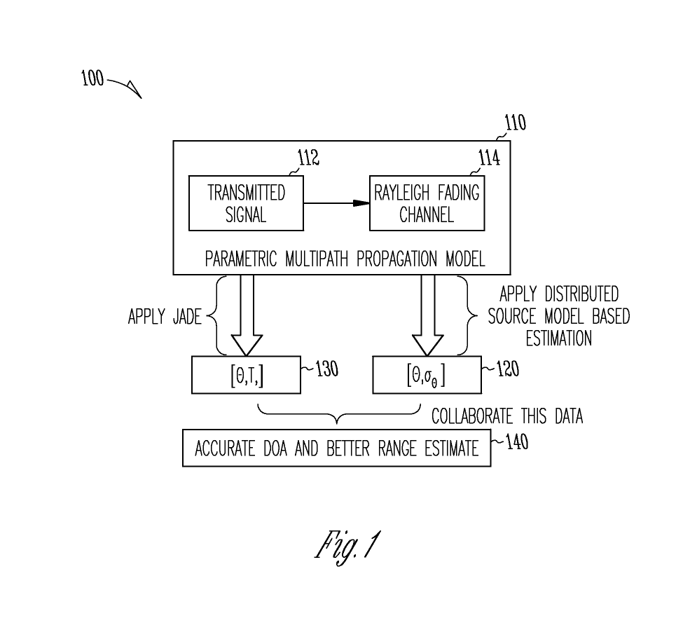

FIG. 1 illustrates a high level block diagram of a system 100 that combines the JADE and DSM approaches. A parametric multipath propagation model 110 submits a transmitted signal 112 to a Rayleigh fading channel 114. The JADE portion generates its output 130, and the DSM portion generates its output 120. The outputs 120, 130 are combined at 140 to generate DOA and range estimations.

Advantages of the combined JADE and DSM two stage approach include a finer resolution than JADE by itself in rich multipath scenarios. The two stage approach works equally well in cases where the line of sight (LOS) is blocked or non-detectable. The two stage approach utilizes the strength of DSM while avoiding the computational burden of a two dimensional search over the entire field of view by providing an initial search point and restricting the range of search to the relevant region.

It should be noted that the JADE algorithm works even if the number of multipath is more than the number of antenna array elements. It gives the shortest delays (TOA) and corresponding angle of arrivals up to few symbols delay spread. If it's a JADE alone for DOA estimate, then the AOA corresponding to the shortest multipath delay (TOA) will be used for location estimate. But due to the reliability requirements and for guaranteed accuracy, more delays and corresponding AOA's will be considered for refining the next level DOA estimate. The delays can spread few symbols, but the AOA's can spread to 0 to 360° in the angular domain. Hence the DSM second stage estimates the RMS angular spread and the actual angle, which can be used for location estimate.

The three dimensional antenna array geometry spanned in three non-collinear planes replaces three base stations assisted for computing the time of arrival or time difference of arrival needed for range information used for any conventional location system. In a spherical co-ordinate system, if the azimuth angle, the elevation angle, and the range are known or can be determined, then the Cartesian co-ordinate data (i.e., x, y, and z) can be determined. Select receivers on a three dimensional plane can be used for phase-of-arrival or phase difference-of-arrival estimation as described below.

In a phase of arrival estimation (POA), the time-of-flight between two objects can be determined using a continuous periodic signal, i.e., a (periodically) modulated RF carrier. The signal generated and transmitted by p (a target radio) is after the time of flight received by unit q (a locator receiver). Internally the locator receiver generates the same signal and performs a cross correlation between the internal and the received signal. If the units are perfectly synchronized, i.e., the signals are generated concurrently, the result of this operation yields the phase difference φ of the two signals. This phase difference is proportional to the distance between the two objects, d. The distance d can then be computed as

$$d = v . T \frac{ϕ}{2 π} ;$$

The term v is the signal propagation speed and the term T the signal period. To avoid any ambiguities d<vT must hold.

A phase difference of arrival estimation (PDOA) is similar to the phase of arrival. A few receivers in the three dimensional plane can be selected to produce a reference for computing the phase difference of arrival. After calculating the phase difference of arrival, the time difference of arrival can be determined. Then, a hyperbolic location principle can be used to fix the range/position.

Applications of the single-station three dimensional location system can be used for emergency route finding for police, fire fighters, and military personnel. The system can also be used to locate illegal transmitters, both broadcast and those used for eavesdropping, and for tracking wild animals that are tagged with tiny transmitters. The below illustration shows how a fire fighter truck mounted DOA receiver system will be used to find the direction and location of the fire fighters inside a building.

An embodiment for three dimensional location and tracking of fire fighters and other personnel can be achieved, as illustrated in the system 200 of FIG. 2, by employing a three dimensional antenna array based DOA receiver that is mounted on a fire truck. The embodiment integrates time/range information with both azimuth and elevation angles of a spherical co-ordinate system. The details of extracting the time and range using a three dimensional non-collinear antenna array based DOA receiver has been explained above. If the range (R), theta (θ), and phi (Φ) are known in a spherical coordinate system, that can be transformed to find the location (x, y, z) of Cartesian coordinates.

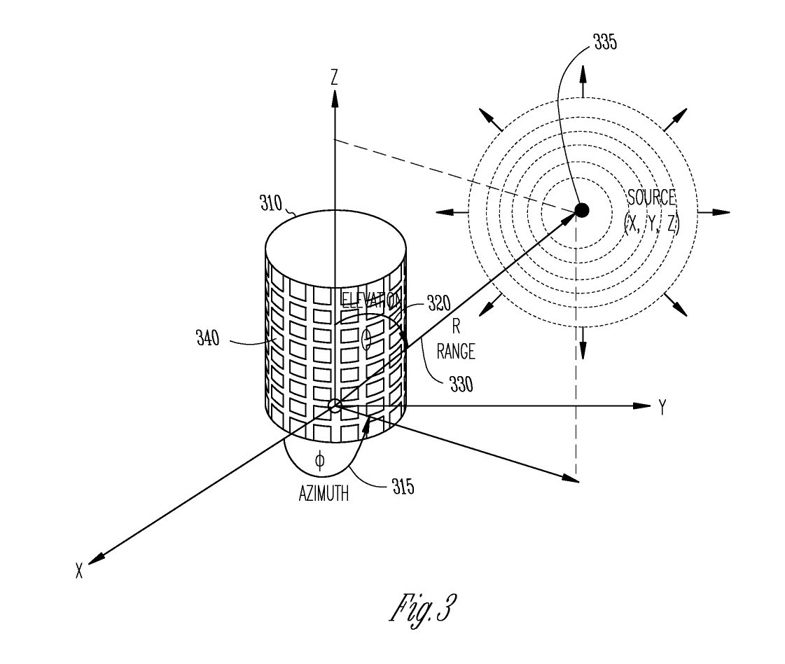

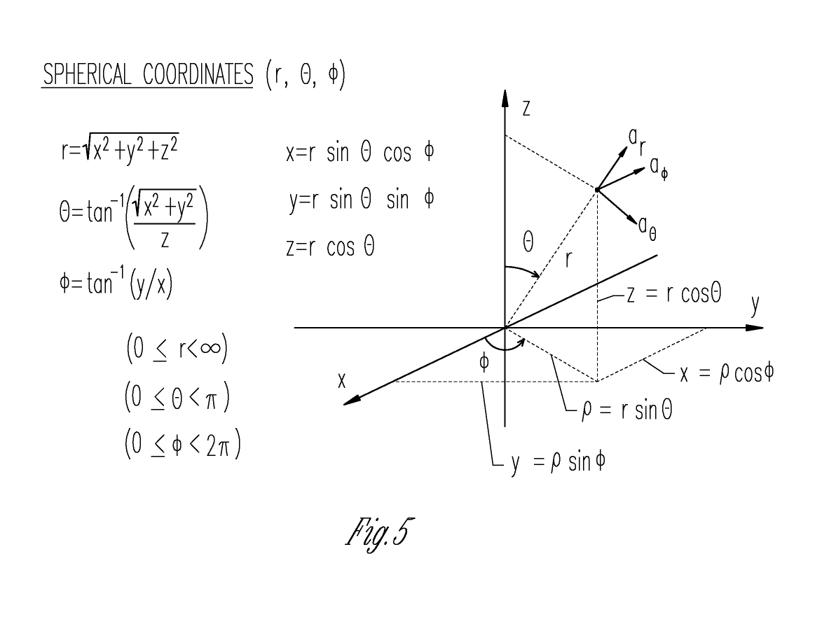

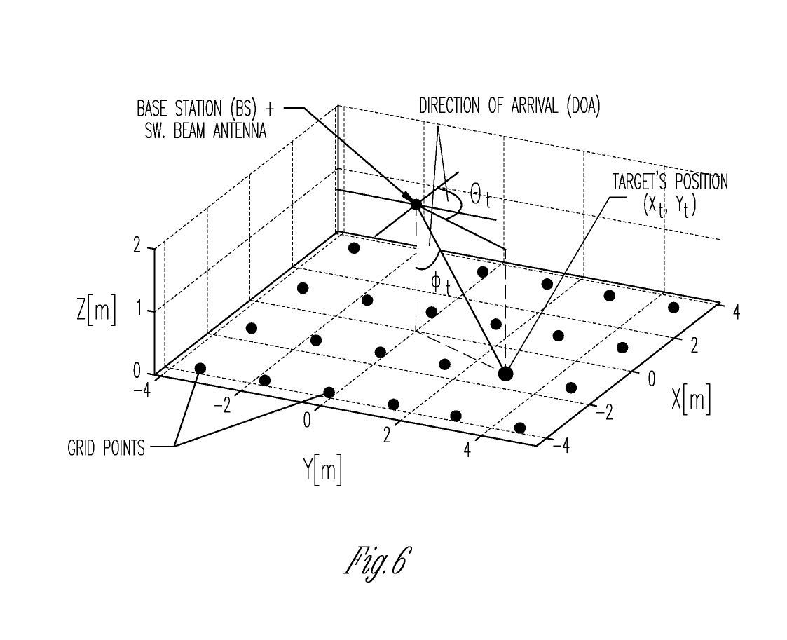

FIG. 3 illustrates how the geometry of a three dimensional antenna array 310 with microstrip patches 340, capable of determining theta (θ) or elevation 320, phi (Φ) or azimuth 315, and range (R) 330 between the antenna 310 and a source 335, can transform those spherical coordinates into x, y, and z coordinates. FIG. 5 illustrates the details of this conversion. FIG. 6 illustrates the relationship between the direction of arrival and a target position.

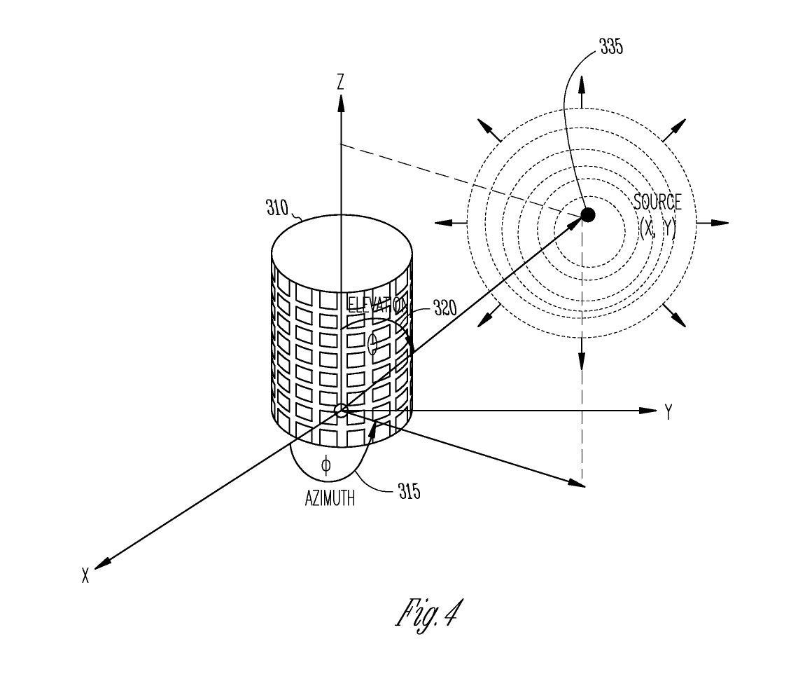

FIG. 4 illustrates how two dimensional angular information from the antenna 310 along with the azimuth 315 and the elevation 320 can be used to find the two dimensional location 335 (x,y). Note that with a fixed antenna position and assuming a target's movement in the plane z=0, there is a one-to-one correspondence between the DOA (θ, Φ) and the target's position (x, y). If m and m⁻¹ are the bijective functions that describe the mapping, then the following relationships hold.

m:(xₜ,yₜ)→(φₜ,θₜ)

m⁻¹:(φₜ,θₜ)→(xₜ,yₜ)

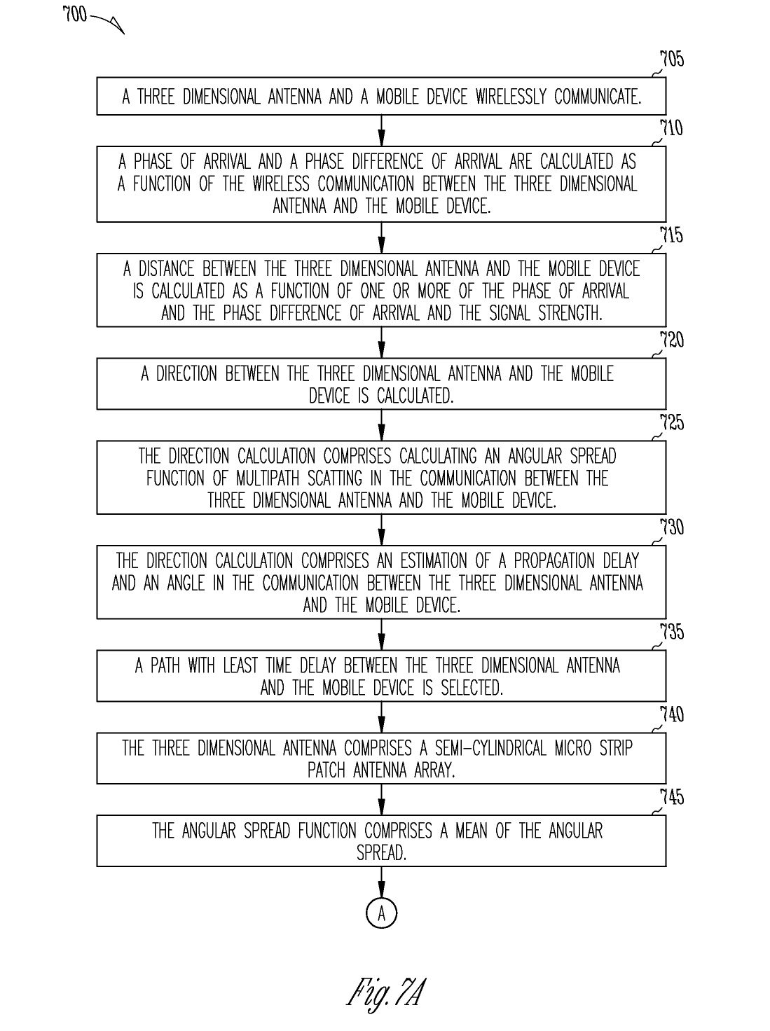

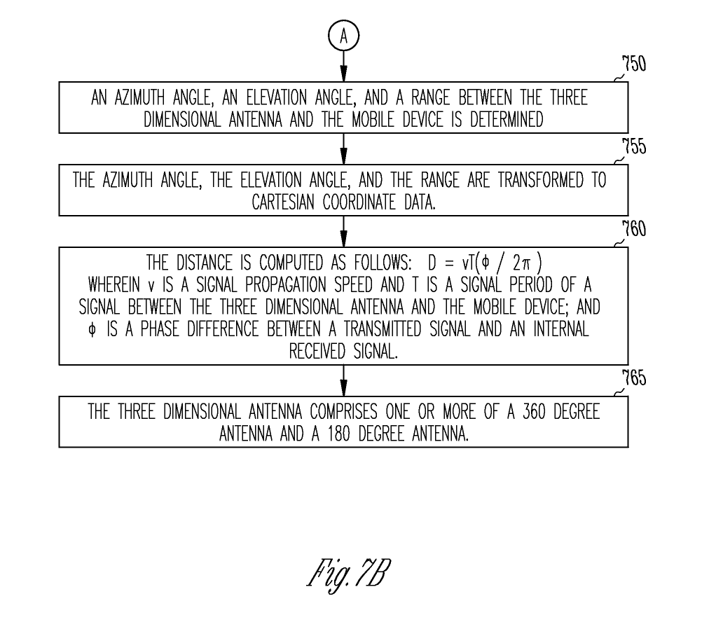

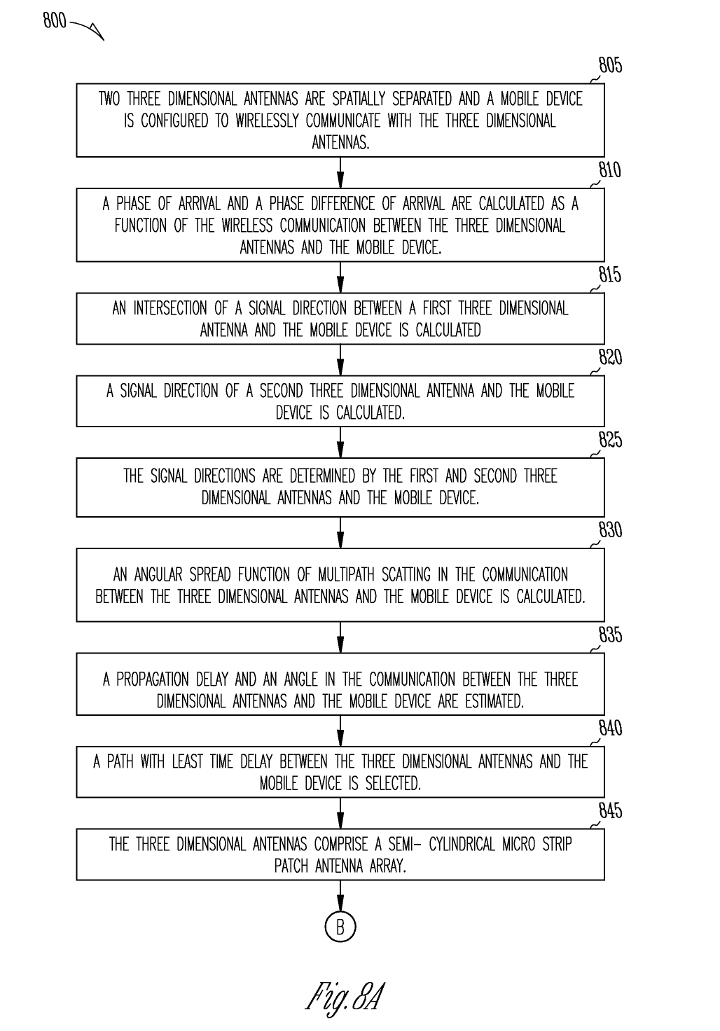

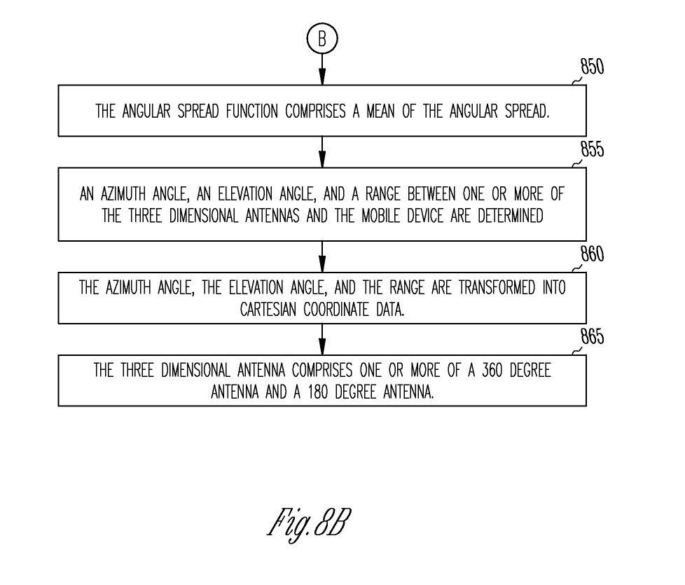

FIGS. 7A, 7B, 8A, and 8B are flowcharts of example processes 700 and 800 for locating mobile devices. FIGS. 7A, 7B, 8A, and 8B include a number of process blocks 705-765 and 805-865 respectively. Though arranged serially in the examples of FIGS. 7A, 7B, 8A, and 8B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 7A and 7B, at 705, a three dimensional antenna and a mobile device wirelessly communicate. At 710, a phase of arrival and a phase difference of arrival are calculated as a function of the wireless communication between the three dimensional antenna and the mobile device. At 715, a distance between the three dimensional antenna and the mobile device is calculated as a function of one or more of the phase of arrival and the phase difference of arrival and the signal strength. At 720, a direction between the three dimensional antenna and the mobile device is calculated. At 725, the direction calculation comprises calculating an angular spread function of multipath scattering in the communication between the three dimensional antenna and the mobile device. At 730, the direction calculation comprises an estimation of a propagation delay and an angle in the communication between the three dimensional antenna and the mobile device.

At 735, a path with least time delay between the three dimensional antenna and the mobile device is selected. At 740, the three dimensional antenna comprises a semi-cylindrical micro strip patch antenna array. At 745, the angular spread function comprises a mean of the angular spread. At 750, an azimuth angle, an elevation angle, and a range between the three dimensional antenna and the mobile device is determined, and at 755, the azimuth angle, the elevation angle, and the range are transformed to Cartesian coordinate data. At 760, the distance is computed as follows:

d=vT(Φ/2π)

wherein v is a signal propagation speed and T is a signal period of a signal between the three dimensional antenna and the mobile device; and Φ is a phase difference between a transmitted signal and an internal received signal. At 765, the three dimensional antenna comprises one or more of a 360 degree antenna and a 180 degree antenna.

Referring to FIGS. 8A and 8B, at 805, two three dimensional antennas are spatially separated and a mobile device is configured to wirelessly communicate with the three dimensional antennas. At 810, a phase of arrival and a phase difference of arrival are calculated as a function of the wireless communication between the three dimensional antennas and the mobile device. At 815, an intersection of a signal direction between a first three dimensional antenna and the mobile device is calculated, and at 820, a signal direction of a second three dimensional antenna and the mobile device is calculated. At 825, the signal directions are determined by the first and second three dimensional antennas and the mobile device. At 830, an angular spread function of multipath scattering in the communication between the three dimensional antennas and the mobile device is calculated. At 835, a propagation delay and an angle in the communication between the three dimensional antennas and the mobile device are estimated.

At 840, a path with least time delay between the three dimensional antennas and the mobile device is selected. At 845, the three dimensional antennas comprise a semi-cylindrical micro strip patch antenna array. At 850, the angular spread function comprises a mean of the angular spread. At 855, an azimuth angle, an elevation angle, and a range between one or more of the three dimensional antennas and the mobile device are determined, and at 860, the azimuth angle, the elevation angle, and the range are transformed into Cartesian coordinate data. At 865, the three dimensional antenna comprises one or more of a 360 degree antenna and a 180 degree antenna.

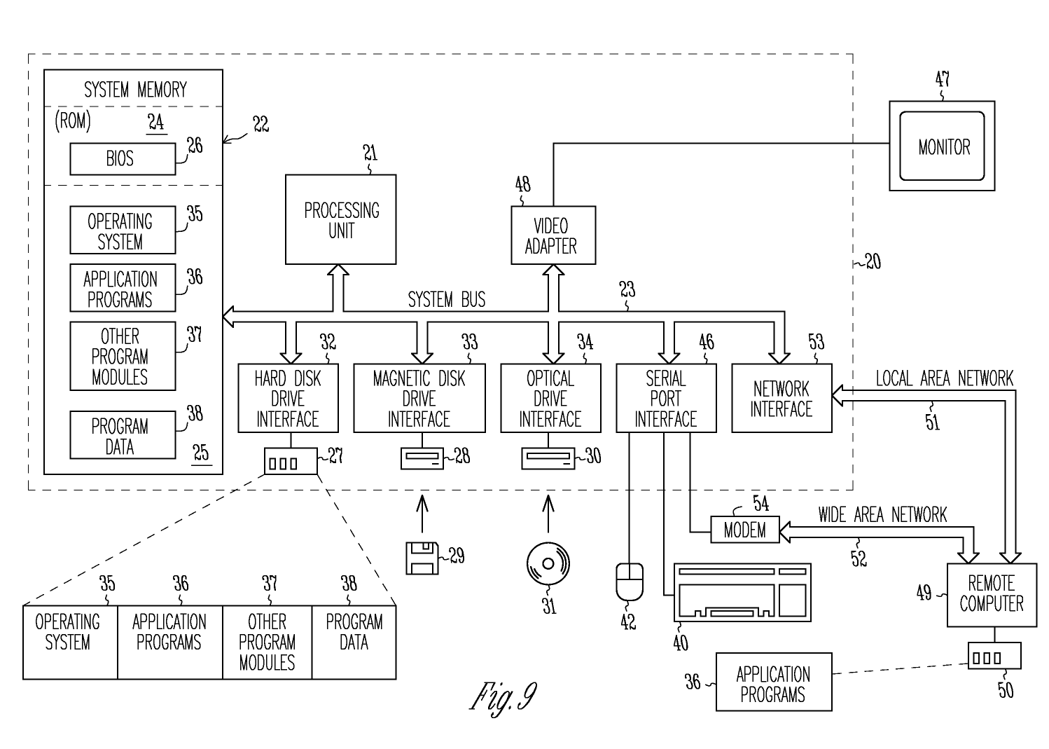

FIG. 9 is an overview diagram of a hardware and operating environment in conjunction with which embodiments of the invention may be practiced. The description of FIG. 9 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 9, a hardware and operating environment is provided that is applicable to any of the servers and/or remote clients shown in the other Figures.

As shown in FIG. 9, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 9 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor;
a three dimensional antenna coupled to the computer processor, the three dimensional antenna comprising a transmitter and a receiver; and
a mobile device comprising a receiver and a transmitter;
wherein the three dimensional antenna and the mobile device are configured to wirelessly communicate;
wherein the computer processor is configured to calculate one or more of a phase of arrival and a phase difference of arrival as a function of the wireless communication between the three dimensional antenna and the mobile device, and is further configured to calculate a distance between the three dimensional antenna and the mobile device as a function of one or more of the phase of arrival and the phase difference of arrival and the signal strength;
wherein the computer processor is configured to calculate a direction between the three dimensional antenna and the mobile device;
wherein the direction calculation comprises calculating an angular spread function of multipath scattering in the communication between the three dimensional antenna and the mobile device; and
wherein the direction calculation comprises an estimation of a propagation delay and an angle in the communication between the three dimensional antenna and the mobile device.

2. The system of claim 1, wherein the computer processor is configured to select a path with least time delay between the three dimensional antenna and the mobile device.

3. The system of claim 1, wherein the three dimensional antenna comprises a semi-cylindrical micro strip patch antenna array.

4. The system of claim 1, wherein the angular spread function comprises a mean of the angular spread.

5. The system of claim 1, wherein the system is configured to determine an azimuth angle, an elevation angle, and a range between the three dimensional antenna and the mobile device, and is configured to transform the azimuth angle, the elevation angle, and the range to Cartesian coordinate data.

6. The system of claim 1, wherein the distance is computed as follows:
d=vT(Φ/2π)
wherein v is a signal propagation speed and T is a signal period of a signal between the three dimensional antenna and the mobile device; and Φ is a phase difference between a transmitted signal and an internal received signal.

7. The system of claim 1, wherein the three dimensional antenna comprises one or more of a 360 degree antenna and a 180 degree antenna.

8. A system comprising:
a computer processor;
two three dimensional antennas coupled to the computer processor, the three dimensional antennas comprising a transmitter and a receiver; and
a mobile device comprising a receiver and a transmitter;
wherein the three dimensional antennas are spatially separated and the mobile device is configured to wirelessly communicate with the three dimensional antennas;
wherein the computer processor is configured to calculate one or more of a phase of arrival and a phase difference of arrival as a function of the wireless communication between the three dimensional antennas and the mobile device;
wherein the computer processor is configured to calculate an intersection of a signal direction between a first three dimensional antenna and the mobile device, and a signal direction of a second three dimensional antenna and the mobile device, wherein the signal directions are determined by the first and second three dimensional antennas and the mobile device;
wherein the direction calculation comprises calculating an angular spread function of multipath scattering in the communication between the three dimensional antennas and the mobile device; and
wherein the direction calculation comprises an estimation of a propagation delay and an angle in the communication between the three dimensional antennas and the mobile device.

9. The system of claim 8, wherein the computer processor is configured to select a path with least time delay between the three dimensional antennas and the mobile device.

10. The system of claim 8, wherein the three dimensional antennas comprise a semi-cylindrical micro strip patch antenna array.

11. The system of claim 8, wherein the angular spread function comprises a mean of the angular spread.

12. The system of claim 8, configured to determine an azimuth angle, an elevation angle, and a range between one or more of the three dimensional antennas and the mobile device, and to transform the azimuth angle, the elevation angle, and the range to Cartesian coordinate data.

13. The system of claim 8, wherein the three dimensional antenna comprises one or more of a 360 degree antenna and a 180 degree antenna.

14. A process comprising:
transmitting a signal between a three dimensional antenna and a mobile device;
calculating one or more of a phase of arrival and a phase difference of arrival as a function of the signal transmitted between the three dimensional antenna and the mobile device;
calculating a distance between the three dimensional antenna and the mobile device as a function of one or more of the phase of arrival and the phase difference of arrival and the signal strength;
calculating a direction between the three dimensional antenna and the mobile device by calculating an angular spread function of multipath scattering in the communication between the three dimensional antenna and the mobile device; and
estimating a propagation delay and an angle in the communication between the three dimensional antenna and the mobile device.

15. The process of claim 14, comprising selecting a path with least time delay between the three dimensional antenna and the mobile device.

16. The process of claim 14, wherein the three dimensional antenna comprises a semi-cylindrical micro strip patch antenna array.

17. The process of claim 14, wherein the angular spread function comprises a mean of the angular spread.

18. The process of claim 14, comprising determining an azimuth angle, an elevation angle, and a range between the three dimensional antenna and the mobile device, and transforming the azimuth angle, the elevation angle, and the range to Cartesian coordinate data.

19. The process of claim 14, wherein the distance is computed as follows:
d=vT(Φ/2π)
wherein v is a signal propagation speed and T is a signal period of a signal between the three dimensional antenna and the mobile device; and Φ is a phase difference between a transmitted signal and an internal received signal.

20. The process of claim 14, wherein the three dimensional antenna comprises one or more of a 360 degree antenna and a 180 degree antenna.
